(19) United States
(12) Patent Application Publication
(10) Pub. No.: US 2001/0032184 A1
(43) Pub. Date: Oct. 18, 2001

(54) Property linked-credit card

(76) Inventor: Samuel Sergio Tenembaum, Punta del Este (UY)

Correspondence Address: Brian P. O'Shaughnessy, BURNS, DOANE, SWECKER & MATHIS, L.L.P., P.O. Box 1404, Alexandria, VA, 22313-1404, US

(21) Appl. No.: 09/749,922

(22) Filed: Dec. 29, 2000

Related U.S. Application Data
(60) Provisional application No. 60/173,476, filed on Dec. 29, 1999.
(60) Provisional application No. 60/194,777, filed on Apr. 5, 2000.

(51) Int. Cl. G06F 17/60

(52) U.S. Cl. 705/41

(57) ABSTRACT

A new type of credit card, the Property Linked-Credit Card, is contractually associated with a specific property, such as a residential house, a shop, a school, a hospital, a car, a yacht, a plane, or other property. The particulars of the subject property in question such as the physical address, license plate number or serial number, are imprinted on the card. All goods and services purchased with the Property Linked-Credit Card are physically delivered to, or rendered in connection with, the registered property. Accounts set up for the Property Linked-Credit Card may be set up by the applicant with a number of optional features. For example, the applicant may have the account set up so that any bearer of the Card with a password can consummate transactions.

This application claims the benefit of U.S. Provisional Application No. 60/173,476 filed in the U.S. Patent and Trademark Office on Dec. 29, 1999, and U.S. Provisional Application No. 60/194,777 filed in the U.S. Patent and Trademark Office on Apr. 5, 2000; the entire contents of each Provisional Application being hereby incorporated by reference.

### FIELD OF THE INVENTION

The present invention relates generally to credit cards. More particularly, the present invention relates to a new kind of credit card linked to a property, rather than being personally linked to an individual in the manner of conventional credit cards.

### BACKGROUND

Credit cards have become an inseparable part of daily life in the modern world. Cash money and other cash-equivalent instruments are gradually being phased out in favor of “plastic money” as the economies of developed nations continue to evolve. Today in the United States, credit cards are used to consummate most retail transactions. Hence, the ubiquitous credit card has become an essential part of commerce in the modern times.

A wide assortment of credit cards are available from various financial institutions issuing credit cards. The competing credit card companies offer an extensive variety of different terms, conditions and attributes. However, despite the plethora of available credit cards, one trait common to all conventional credit cards is that each card is linked to a specific person. That is, all conventional credit cards, e.g., personal, business, or corporate credit cards, are issued to a “Cardholder” or “Cardmember.”

### SUMMARY

A need exists for a more innovative approach to meet the changing patterns of the consumer market. The present invention, referred to herein as a “Property Linked-Credit Card,” offers a new approach in credit cards that yields benefits not previously realized. Rather than being linked to a specific person, a credit card of the present invention is associated with a property such as a house, a car, a yacht, a shop, an institution, or other types of real property or personal property. In one embodiment of the present invention, a transaction using the Property Linked-Credit Card is consummated by delivering to, or through verification of, a property feature, such as a house address, a car plate number, a yacht license number, a shop address, an institution address, an e-mail address, or other property feature.

One advantage of the Property Linked-Credit Card is that purchased services or products may be specified in advance by the terms and conditions of the credit card for physical delivery, or performance, only to the underlying property. In accordance with this embodiment, the Property Linked-Credit Card has the relevant details of the property imprinted or magnetically encoded on the credit card for easy identification, e.g., house address, license plate number, or serial number.

Another advantage of the Property Linked-Credit Card is the extra amount of security afforded in making credit card transactions, as compared to using an ordinary credit card. Fraudulent use of the Property Linked-Credit Card is more difficult because the delivery of goods or performance of the services is specified for a predetermined address, property or vehicle. This feature makes the Property Linked-Credit Card a more secure means of payment for Internet transactions and telephone orders. Furthermore, if a Property Linked-Credit Card gets lost or stolen, it is of relatively little use to a party with illicit intentions since the products and services are specified for a property. As an additional measure of security, the card applicant may specify a password to be provided by a card bearer as a requirement to carry out a transaction using the Property Linked-Credit Card.

Another benefit of the Property Linked-Credit Card is an added amount of flexibility in allowing others to use the card. Since the card is linked to a specific property, any card bearer who knows the password can use the card. For example, a maid would not be able to shop on behalf of her employing household using a traditional credit card, unless the card was issued in the maid's name. Instead, it would be necessary for the maid to either carry cash, which is often dangerous, or have a card holder accompany the maid to pay the shopping bill.

As an added measure of flexibility, the applicant of the Property-Linked Credit Card has the capability of selecting among different options for various authorized bearers of the card. For example, the maid's password could be associated with preset spending limits, predefined shopping neighborhoods, etc. In one embodiment, different card bearers, each having their own password, may be provided with different options For example, the maid's password may be associated with one spending limit, while the teenage daughter has a different password which is associated with a different spending limit.

Further benefits of the Property Linked-Credit Card include better money management and control of expenditure amounts. The Property Linked-Credit Card provides an excellent real time picture of the expenditures made in relation to the property in question. The monthly statements of the Card reflect the dates, amounts and locations of transactions, and also disclose a breakdown of each purchase. These features enable better management and control of expenditures.

The Property Linked-Credit Card also affords greater confidentiality in using the card. The card bearer may remain anonymous in the sense that the card bearer does not have to provide a personal I.D. or proof of identification. The card bearer need only know the password, or other confidential identification device, to use the card. Further, the card applicant may remain entirely anonymous in that the card applicant need not even be present for a transaction. For example the card applicant can send the maid or other card bearer to the store instead of going personally.

According to one embodiment of the present invention, a card issuer finances the purchases of a card bearer who is using a Property Linked-Credit Card associated with a specified property. The card issuer establishes an agreement with a card applicant who has possessory authority over the specified property. The card applicant agrees to pay the card issuer for any debts from purchases made with the Property Linked-Credit Card. Upon making such an agreement, the card issuer issues the Property Linked-Credit Card to the card applicant. Merchants allow the card bearer to use the Property Linked-Credit Card for financing purchases of goods and services. The merchants agree with the card issuer to deliver any purchases to the specified property.

In accordance with another embodiment of the present invention, a card issuer finances the purchases of a card bearer who is using a Property Linked-Credit Card associated with a vehicle. The card issuer and a card applicant with possessory authority over the vehicle form an agreement whereby the card applicant pays the card issuer for any debts incurred with the Property Linked-Credit Card. The card issuer issues the Property Linked-Credit Card to the card applicant upon establishing such an agreement. Then a card bearer can use the Property Linked-Credit Card for financing purchases at various merchants. The merchants agree with the card issuer to only consummate the purchases of a card bearer who has aforementioned vehicle in immediate possession.

In accordance with another embodiment of the present invention, a card bearer using a Property Linked-Credit Card which is associated with a specified property may make purchases of goods or services. The card bearer, who has established possessory authority over the specified property, presents the card to a merchant for a transaction to purchase goods or services. The card bearer then accepts delivering of the goods or services at the specified property.

According to yet another embodiment, a card bearer using a Property Linked-Credit Card associated with a specified property establishes possessory authority over the specified property. The card bearer presents the card to a merchant for a purchase. The card bearer allows the merchant to verify the card bearer's possessory authority over the associated property as a precondition for the transaction, upon such verification, receives the purchased goods or services of the transaction.

### BRIEF DESCRIPTION OF THE DRAWINGS

The foregoing brief description, as well as further objects, features and advantages of the present invention will be understood from the following detailed description of presently preferred embodiments, with reference being had to the accompanying drawing, in which:

FIG. 1 is a system diagram depicting relationships between various aspects of the Property Linked-Credit Card, in accordance with the present invention;

FIG. 2 depicts exemplary aspects of a Property Linked-Credit Card including information collected at the time of application, in accordance with the present invention;

FIG. 3 is a flowchart of an exemplary method of issuing the Property Linked-Credit Card, in accordance with the present invention; and

FIG. 4 is a flowchart of an exemplary method of using a Property Linked-Credit Card for purchases, in accordance with the present invention.

### DETAILED DESCRIPTION

These and other aspects of the invention will now be described in greater detail in connection with a number of exemplary embodiments.

The present invention provides a method of financing purchases using a Property Linked-Credit Card associated with a specified property. The method comprises: establishing an arrangement between a card issuer and a card holder under which the card issuer will pay a merchant for a purchase made by the card holder using the card, and the card holder will pay the card issuer for that purchase, and under which the card holder establishes a possessory authority over a specified property; issuing the Property Linked-Credit Card to the card holder upon the establishment of said agreement; and establishing an arrangement between a merchant and the card issuer under which the merchant charges a purchase made by the card holder against the card holder's card and obtains payment for that purchase from the card issuer, and limits the delivery of the purchase to the specified property.

In the foregoing embodiment, the financing arrangement as between card issuer, card holder, and one or more merchants is similar to that which exists in a typical credit card transaction, and can include provisions for the payment of interest.

Use of the term “card” contemplates any means for associating a legal entity with an account, and should not be limited to the use or existence of an actual physical card, per se. Likewise, the use of the terms “card issuer,” “card holder” and “card applicant” are not limited to enterprises that actually issue or hold cards, but rather can include, for example, legal entities capable of engaging in an arrangement for the advancement of credit or other financing arrangements. The terms “card holder” and “card applicant” are used interchangeably herein. Accordingly, the use of the term “Property Linked Credit Card” should not be limited to those accounts or arrangements involving the use or issuance of a card, per se.

The specified property might be a home, business, vehicle, or any other real property, asset, commercial enterprise, or other identifiable item of value.

Use of the term “merchant” contemplates any purveyor of goods and/or services; and the term “purchase” contemplates any acquisition of an ownership, proprietary, or possessory interest in any property or asset.

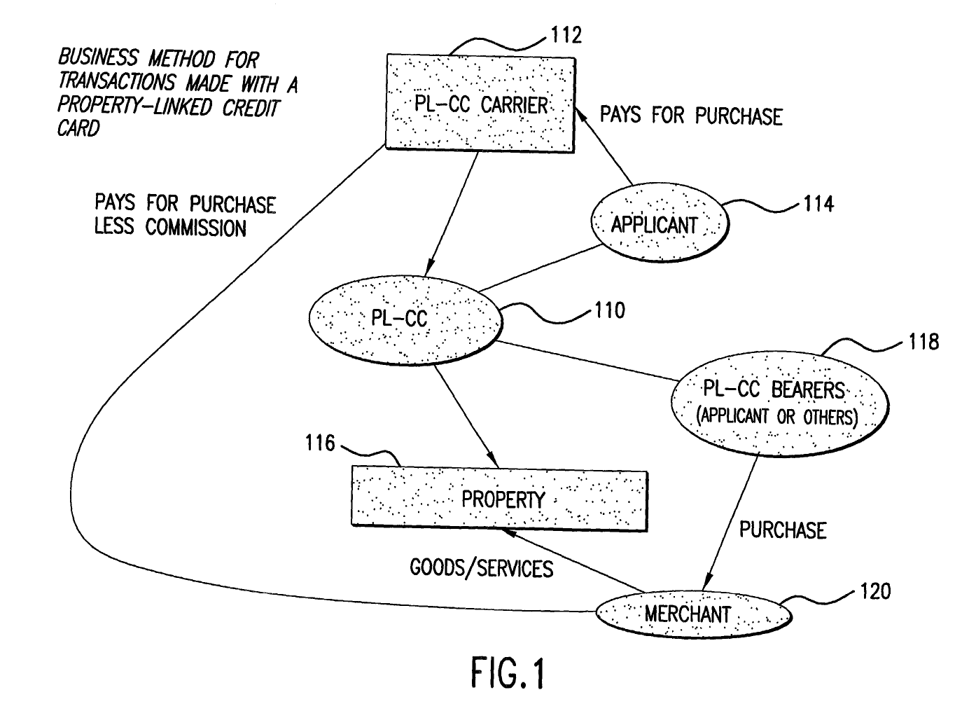

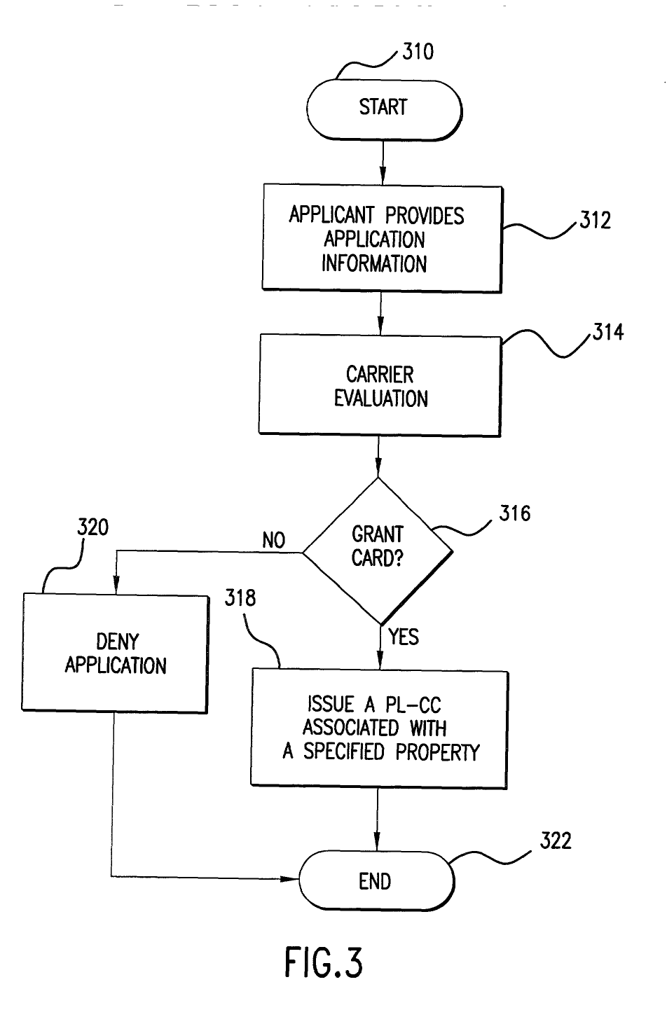

FIG. 1 is a system diagram depicting relationships between various aspects of the Property Linked-Credit Card 110. The Property Linked-Credit Card (PLCC) carrier §112 is the financial institution which issues the Property Linked-Credit Card 110 to an applicant 114. The applicant 114 may be an individual, a corporation, or any other legal entity or card holder capable of obtaining a line of credit or credit card. The applicant 114 applies the PL-CC carrier §112 for issuance of a Property Linked Credit Card 110 by filling out the appropriate application forms and providing the required information. The issuance of the Property Linked Credit Card 110 involves the establishment of an agreement between the PL-CC carrier §112 and the applicant 114 under which the carrier §112 agrees to pay merchants for any purchases made by the applicant 114 using the Property Linked Credit Card 110. The application process is discussed further in conjunction with FIG. 3.

PL-CC bearers 118 comprise one or more individuals who have a physical copy of the Property Linked-Credit Card 110, or the necessary information and authorization to conduct transactions with the Card 110. For example, the PL-CC bearers 118 include those individuals having the necessary information (e.g., card number or appropriate phone line, and password if any) to consummate a transaction via the Internet or by telephone or like mode of communication. The applicant 114 might be a card bearer 118.

In accordance with one embodiment, multiple copies of a Property Linked-Credit Card 110 may be associated with a single account of an applicant 114. For each of these multiple copies, the applicant 114 will optionally specify a predetermined credit limit or transaction limit, or limit the transactions to particular purchases (e.g., Internet purchases only, or purchases only at a specific grocery store). That is, the applicant 114 might specify various sets of options associated with the respective passwords of each PL-CC bearer 118 of the Property Linked-Credit Card 110.

Merchant 120 represents any business that will accept the Property Linked-Credit Card 110 in return for goods and services. Such goods and services are defined to include any type of valuable consideration. Depending upon the particular card options chosen by the Applicant 114, the merchant 120 may be authorized to deal solely upon presentation of a physical copy of the Property Linked-Credit Card 110, or may be authorized to accept the Card's information over the telephone or Internet.

The property 116 is the property associated with the Property Linked-Credit Card 110. For example, the property 116 might be a house, an automobile, a boat, or other real estate, vehicle or tangible property associated with the Property Linked-Credit Card 110 during the application process. The property 116 can be owned or controlled by the applicant 114. However, the applicant 114 does not necessarily need to be the owner of the property linked to the Property Linked-Credit Card 110. The property 116 can be owned or controlled by another person or legal entity specified by the applicant 114. For example, a father could obtain a card to be used by a child of his who is away at college, with the college student child's address being specified as the property.

In an alternative embodiment, the property 116 might be a property having an identifiable feature, such as a telephone line identified for telephone or Internet transactions using a caller ID feature available through the telephone company, or an e-mail account or Internet site having a specified e-mail or Internet address. In accordance with another embodiment of the invention, the property 116 may be intangible property having some amount of value, e.g., a bank account, a stock portfolio, licensing rights, or other like type of intangible property.

During the application process, the applicant 114 might contractually obligate the property 116 as a security interest for the Property Linked-Credit Card 110. In an alternative embodiment, the applicant 114 might be personally liable for expenditures made using the Property Linked-Credit Card 110, with the Card 110 being used for a specified delivery location (e.g., a house address specified as the property 116 to which all goods must be delivered), or for identification/verification purposes (e.g., groceries may only be sold to a PL-CC bearer 118 driving an automobile or other vehicle specified as the property 116).

In general, the card bearers 118 purchase goods or services from the merchant 120. The merchant 120 sends the purchased goods or services to the property 116 in accordance with the options specified for transactions. The applicant 114 pays for the transaction to the PL-CC carrier §112, who, in turn, pays the merchant 120, after discounting a commission for the PL-CC carrier §112.

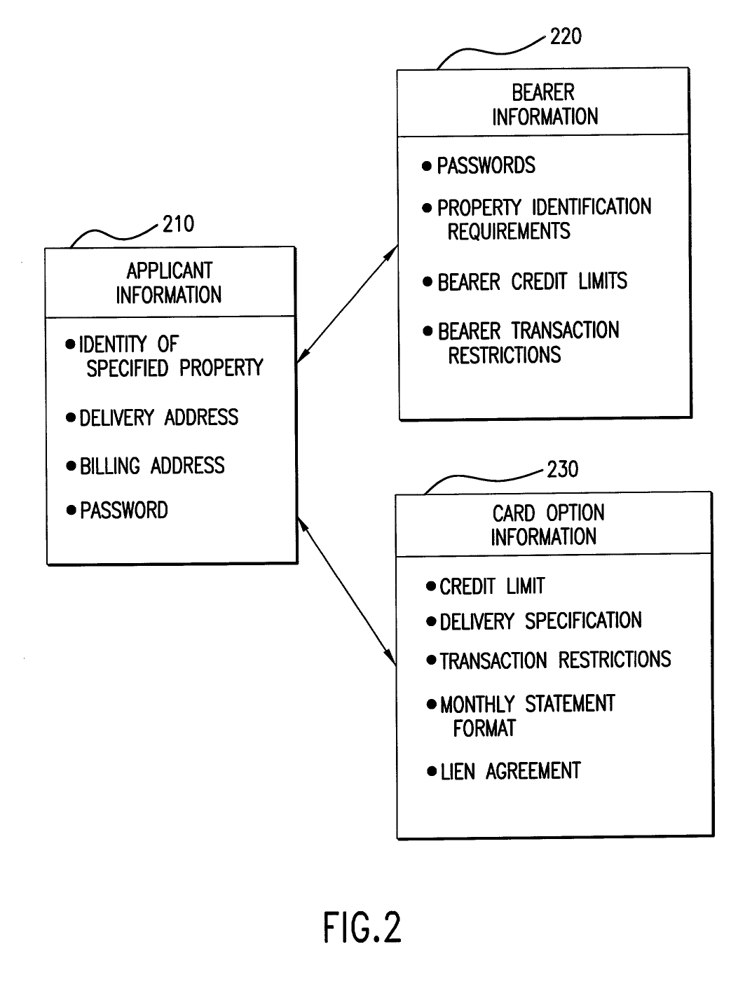

FIG. 2 illustrates some exemplary aspects of a Property Linked-Credit Card, in accordance with the present invention, including the information collected at the time of application for the card and some options that might be specified for the card. In general, the basic and optional features of the Property Linked-Credit Card are specified during the time of application. The options for the card can be changed or added by the applicant at a later date, if such options are authorized by the carrier of the PL-CC. Three general categories of information include applicant's information 210, bearer information 220 and card option information 230.

The applicant's information 210 includes information pertaining to the applicant, or legal entity, applying to a credit card carrier for a Property Linked-Credit Card. Although the PL-CC is linked or “associated” to a specified property, the PL-CC applicant is a legal entity, which might be one or more persons or a business. Upon approval of the PL-CC application by the card carrier, the PL-CC will be issued to the legal entity that applied for it. That legal entity might then distribute the card or cards to other bearers. The criteria for issuing a PL-CC card is similar to the criteria conventionally used by the credit card industry. The use of the specified property as collateral is an option, but is not a requirement for issuance of a PL-CC. The PL-CC might be backed by other valuable consideration, or by a promissory note of the applicant or other legal entity willing to back the card.

The applicant's information 210 includes identification of a predefined, “specified property” associated with the Property Linked-Credit Card. The specified property can be one or more of the following: a building or real estate having a physical address (e.g., a house, a shop, an institution, or the like), a vehicle having a predefined license or matriculation number (e.g., a cars, a boat, a plane, or the like); an item of personal property having a serial number or other identifying mark (e.g., an electronic device, a household appliance, or the like); or other tangible property that can readily be identified. In preferred embodiments, products and/or services purchased with the Property Linked-Credit Card will be physically delivered to, or rendered in connection with, the specified property with which the Card is associated. Therefore, during the collection of application information, the applicant will be asked for the delivery address and billing address, both of which may be the specified property itself in the case of real estate being used for the specified property.

The specified property is “associated” with a Property Linked-Credit Card in that the specified property is identified as such on the application for the Property Linked-Credit Card. In a preferred embodiment, the specified property is used as a delivery point (e.g, a house, business or car), and/or an ordering point (e.g., a telephone number or e-mail address), or otherwise serves as identification for, or verification of, the card bearer. The delivery address is specified as part of the applicant's information 210. The billing address, which may or may not be the same as the delivery address, is also specified in applicant's information 210.

The bearer information 220 includes information provided by the applicant pertaining to one or more bearers specified for a Property Linked-Credit Card. In accordance with preferred embodiments, the bearer information need not include the names or identities of particular people who are to be the bearers. In these embodiments, the bearer information is associated with particular cards that are presented to merchants. Alternatively, the bearer information is associated with one or more passwords to be provided in making a transaction with a card, or with multiple cards.

The bearer information 220 might include password information for one or more of the card bearers. The optional security password requirement provides the Property Linked-Credit Card with an added measure of security, even though illicit use is less likely to occur than in the case of regular credit cards, due to the “dispatch goods to specific address” feature. Such a password requirement serves to restrict access to the PL-CC. That is, a transaction cannot be performed without providing the proper password. The password will be known by those authorized card bearers specified by the applicant. In addition, different card bearers may each have their own password, wherein each password has expenditure restrictions or other such limitations or terms of use associated with it. In this way, a single physical PL-CC may be used by different card bearers (e.g., members of a family), with each card bearer having his/her own expenditure capabilities or restrictions. The following exemplary scenarios illustrate various possible forms of the Property Linked-Credit Card.

In alternative embodiments, the bearer information 220 specified by the applicant includes predetermined expenditure restrictions for a particular physical card, or for each card bearer that the applicant authorizes to use the Property Linked-Credit Card. The purchasing restrictions may limit the place of purchasing, the types of goods or services being purchased (e.g., no alcohol; or only groceries). The applicant of the Property Linked-Credit Card may also specify geographical purchasing restrictions. For example, the applicant might specify that goods and services can be purchased only in one or more of: a zip code, a city, a state, or like geographic region. The applicant of the Property Linked-Credit Card can also specify geographical purchasing restrictions, e.g., no transactions on Santa Monica Blvd. The applicant can specify the purchasing restrictions for one or more card bearers, or for the Property Linked-Credit Card itself.

The applicant of the Property Linked-Credit Card might also specify a restriction as to a particular type of transaction for one or more of the card bearers. For example, a card bearer may be limited to conducting Internet transactions only, or conversely, might be prohibited from transacting via the Internet. Similarly, a card bearer might be restricted to (or prohibited from) conducting face-to-face transactions only, or transactions via the mail, or by telephone.

The applicant of the Property Linked-Credit Card also has the option of setting a predefined spending limit as a restriction. The spending limit may be specified for each particular bearer, or in total for a Property Linked-Credit Card. Additionally, the spending limit can be specified in terms of various spending parameters, including one or more of the following: spending per period, per transaction, per method of presentation (e.g., over the counter limits, Internet limits), per type of product or service. The spending limits can be specified either by themselves or in combination. For example, a card bearer might be limited to spending no more than $250 per month, of which no more than $50 is spent at gas stations. The applicant might also specify certain merchants or products/services as not being approved (e.g., no gas station expenditures allowed at all).

The card options information 230 includes information provided by the applicant pertaining to the Property Linked-Credit Card itself, and to the account for the Property Linked-Credit Card. The card options information 230 comprises restriction information similar to that described above pertaining to the bearer information 220, except that such restrictions are for the overall account of the Property Linked-Credit Card rather than for individual bearers.

The card options information 230 includes the specification of the reporting statement format for the monthly statements, or other periodic or special statements (e.g., yearly statements, overdraft statements). To provide additional expenditure information and management control, the monthly statements of the Property Linked-Credit Card can be tailored to include various breakdowns of information specified by the applicant. For example, the monthly statements might be specified to include the amount and date of each transaction, and also a detailed breakdown of the purchased products or services by category, or a description line of each transaction. A single monthly report can be provided that provides a compilation of all transactions without distinguishing between the purchases of different card bearers. Alternatively, the report may be tailored to provide a breakout of each bearer's expenditures.

In accordance with one embodiment, the applicant and authorized users or card bearers can access their account information via the Internet by using a special password. The account information can be specified to include a variety of categories or useful cross sections to enable the card applicant to understand and analyze spending patterns or consumption trends. For example, the applicant could specify a spending report to identify how much gas was purchased with the card, or how much food was consumed during a certain month, or even how many calories were consumed. In an addition embodiment, the card applicant can provide access to, or sell, his/her account information (partially or totally) to commercial businesses that use such information, for example, to carry out direct advertising programs or to contact directly the consumer.

In the following exemplary scenario, the specified property is a particular household property used to restrict the usage of a Property Linked-Credit Card. A household credit card is contractually associated to a hypothetical house domicile, e.g., 2310 Windsor Road, Alexandria, Va., 22307. When the maid of the aforementioned household goes to shop for groceries at a nearby grocery store, she pays for the groceries with the household credit card. Because of the options specified by the applicant, the merchant is compelled to deliver the groceries to the registered house address as it appears in the household credit card, once the transaction has been properly authorized and cleared. The application agreement for the household credit card of this example can be specified such that the purchased items cannot be carried away by the maid, nor dispatched to any address other than the authorized one. A household credit card as mentioned in this example is very suitable for the purchase of goods or services in connection with a house, maintenance or repairs, private lessons, groceries, or other household items.

In an alternative exemplary scenario, the car credit card is contractually associated to a specific car, e.g., hypothetical license plate number NY 2356. A card bearer who is the car owner, the chauffeur, or any other authorized driver, may pull into a gas station and to fill up the car's gas tank. The gas station merchant, as instructed during the credit card authorization process, is compelled to verify that the car's plate number coincides with the particulars that appear on the car credit card. The Property Linked-Credit Card provides security against fraudulent transactions since a transaction cannot be verified for approval to fill up another car.

Another exemplary scenario is a Property Linked-Credit Card with a yacht or other boat serving as the specified property. The yacht credit card combines certain features of the aforementioned household card and the car credit card. A yacht card may serve as a physical address to which products/services may be delivered or performed (e.g., groceries, travel items, cleaning services). At the same time, a yacht is also a transportation machine that requires fuel, spare parts, and maintenance akin to a car (e.g., gasoline).

In another exemplary scenario, a shop, office, or business may serve as the specified property for a Property Linked-Credit Card. A shop needs all kind of products and services that can be bought with a credit card, such as stationery and office supplies, or cleaning and maintenance services. In the present scenario, the Shop Credit Card would be linked to the shop's physical address. Similarly, institutions such as schools, hospitals, or the like, are also consumers of products and services that can be bought with a credit card. Hence, an Institution Credit Card may be contractually associated with a specific institution's physical address for delivery of goods or performance of services purchased with the card.

FIG. 3 is a flowchart of an exemplary method of issuing the Property Linked-Credit Card, in accordance with the present invention. The method starts in step 310 and proceeds to step 312 where the applicant provides application information for obtaining a Property Linked-Credit Card. The application information includes a description of the property to be associated with the credit card, e.g., a house address, an automobile license plate, airplane or boat registration papers. The specified property can either belong to, or be under the control of, the applicant, or alternatively can belong to, or be under the control of, another person specified by the applicant.

The application information can also include a valuation of the property, as well as information pertaining to any liens against the property or applicable title information. In particular, any information pertaining to the value of the property is appropriate for collection as application information, since the property can be used as a security interest against the Property Linked-Credit Card in accordance with one alternative embodiment. Alternatively, the Property Linked-Credit Card may be backed by one property as a security interest (e.g., a house) and use another property for identification purposes (e.g., a car license plate).

Additional information may be gathered in step 312 as to the options for the Property Linked-Credit Card which applicant would like to have enacted. For example, the applicant can specify passwords, if any, for one or more bearers who will be authorized to use the Property Linked-Credit Card. The application information might further include any of the other various options available for the card, such as the delivery address, billing address, credit limits for various bearers, bearer transaction restrictions, or other like options. Once the applicant's application information has been provided in step 312, the method proceeds to step 314 for evaluation of the application.

During step 314, the credit card carrier issuing Property Linked-Credit Cards evaluates the application information to evaluate the risk in issuing a card to the applicant. In accordance with alternative embodiments, the Property Linked-Credit Card can be backed by a security interest in the property linked through the card, or might be backed by another property serving as a security interest, or might be backed solely by the applicant's contractual obligation. Once the carrier has evaluated the application information in step 314, the method proceeds to step 316 for an indication of whether or not to grant the card to the applicant.

For a negative application decision, the method proceeds in accordance with the “no” branch from step 316 to step 320 where the application is denied. The method then proceeds to step 322 and the method ends. If, in step 316, the carrier decides to grant a Property Linked-Credit Card to the applicant, the method proceeds in accordance with the “yes” branch from step 316 to step 318. In accordance with step 318, an agreement is established between the carrier and the applicant under which the carrier pays merchants for purchases made by the applicant. In addition, in step 318 any further details necessary for issuing the card are attended to (e.g., further specification of options, informing the applicant of the dollar amount of the credit line). The Property Linked-Credit Card is then issued to the applicant in step 318, and the method proceeds to step 322 where the method ends.

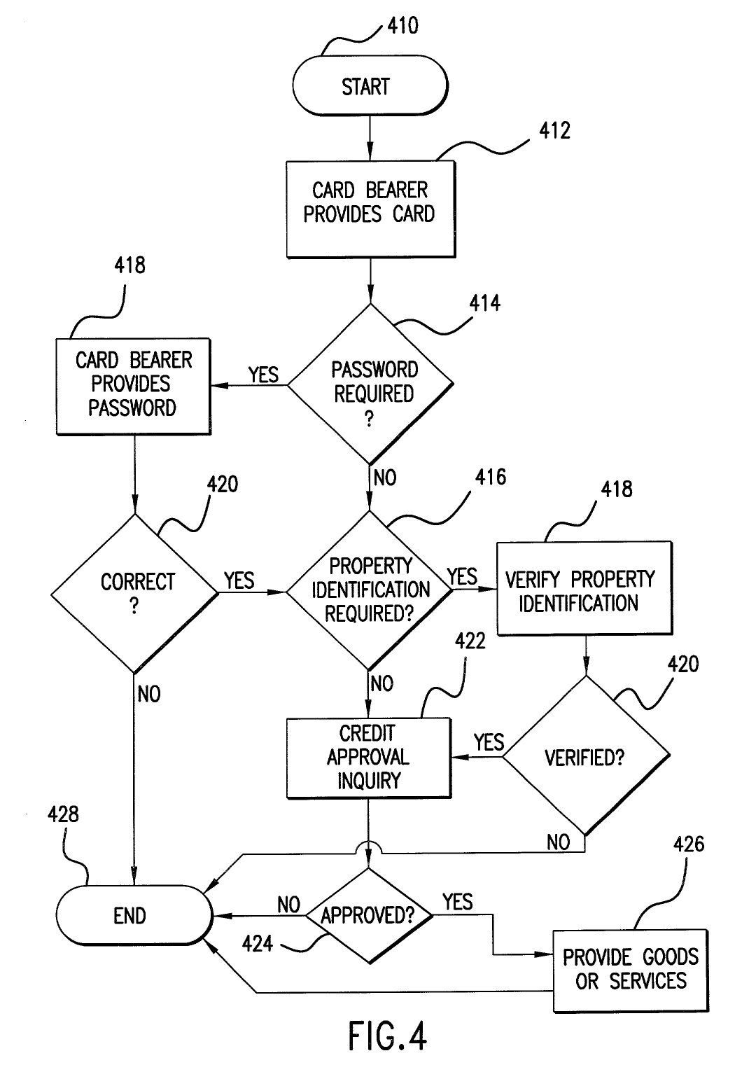

FIG. 4 is a flowchart of an exemplary method of using a Property Linked-Credit Card for purchases, in accordance with the present invention. The method begins in step 410, and then proceeds to step 412 where the card bearer provides the card to the merchant or business entity with whom the transaction is desired. Step 412 might consist of physically providing the Property Linked-Credit Card to a merchant, or conveying information of the Property Linked-Credit Card to the merchant over the telephone, the Internet, or a like communication system. Upon providing such information, or the Property Linked-Credit Card itself, to the merchant in step 412, the method then proceeds to step 414 for handling of passwords, if any. A password might be specified by an applicant as a requirement for card bearers to demonstrate, or exert, possessory authority over the specified property.

If a password is required to consummate a transaction for the particular Property Linked-Credit Card being used, or if a password is required for the bearer making the purchase, the method proceeds in accordance with the “yes” path from step 414 to step 418. In step 418, the card bearer provides the password to the merchant, again, either communicating it directly to him if the card is being physically presented or communicating it via the telephone, Internet, or other like communication network. Upon providing the password to the merchant, the method proceeds from step 418 to step 420 where it is determined whether the password is correct or not. If the password is not correct, the transaction will not be consummated. In accordance with one embodiment, directions are given to the merchant to seize the Property Linked-Credit Card for a failed password as a security measure to avoid the use of stolen cards. When a password fails, the method proceeds in accordance with the “no” branch from step 420 to step 428 where the method ends. If, on the other hand, the bearer provides the correct password, the method proceeds in accordance with the “yes” branch from step 420 to step 416.

Back in step 414, if it is determined that no password is required, the method proceeds in accordance with the “no” branch from step 414 to step 416 where a determination is made as to whether property identification is required to consummate the transaction. If such property identification is required, the method proceeds in accordance with the “yes” branch from step 416 to step 418, which pertains to an embodiment of the present invention requiring property identification in order to consummate a transaction. For example, a Property Linked-Credit Card might be linked to an automobile. In such an embodiment, only a bearer of the card driving the subject automobile could make a purchase with the Property Linked-Credit Card. If a bearer driving the automobile was purchasing groceries, the grocery store checkout clerk would verify that the car was parked in the grocery store parking lot. The sale could then be carried out and the groceries could be delivered directly to the car, thus, verifying the property's identification prior to consummating (e.g., by delivering) the transaction.

In another exemplary situation, a particular telephone number is the specified property for a Property Linked-Credit Card. The card bearer placing the telephone order is identified by the tele-merchant through the use of caller ID. In both of these examples, control of the property itself (e.g, driving the specified automobile and calling from the specified telephone number) demonstrates, or exerts, possessory authority over the specified property.

Once the information for identifying the property has been provided in step 418, the method proceeds to step 420 where it is determined whether the information is correct. If the property has been correctly verified and the bearer is determined to have possessory authority over the specified property, the method proceeds in accordance with the “yes” branch from step 420 to step 422. In the event that the property is not verified in step 420, the method proceeds in accordance with the “no” branch to step 428 where the method ends.

Step 422 pertains to a credit approval inquiry performed by the merchant. Step 422 may be entered in accordance with the “no” branch from step 416 if no property identification is required, or may be entered in accordance with the “yes” branch from step 420 if property identification is required and has been correctly verified. In step 422, the merchant communicates with the carrier of the Property Linked-Credit Card for an approval of the transaction. The credit approval inquiry might involve providing the carrier with the amount of the transaction presently being carried out, and other information akin to a credit card transaction, to ascertain whether there is a sufficient credit limit on the Property Linked-Credit Card and approval to consummate the transaction. In practice, an inquiry about verification of property identification and the credit approval inquiry may be performed during the same communication with the carrier. That is, the card need only be “swiped” once through a card reader, and steps 418, 420 and 422 may be conducted during the same communication. The method then proceeds from step 422 to step 424 where it is ascertained whether the credit approval inquiry has been approved.

If the transaction is approved by the carrier, the method proceeds in accordance with the “yes” branch from step 424 to step 426 where the merchant provides the goods or services. In accordance with a preferred embodiment, the merchant provides the goods or services by having them delivered to the specified property. For example, the merchant may ship the goods and services to a predetermined address of the specified property. Alternatively, the Property Linked-Credit Card may be set up such that the merchant is authorized to provide the goods and services to a bearer driving an automobile identified by a certain license plate, the automobile serving as the specified property. Upon providing the goods or services, the transaction is consummated and the method proceeds to step 428 where it ends. In step 424, in the event the transaction is not approved, the method proceeds in accordance with the “no” branch to step 428 where the method ends.

Some aspects of the invention may be performed by elements of a computer system, by specialized circuits (e.g., discrete logic gates interconnected to perform a specialized function), by program instructions being executed by one or more processors, or by other like processing systems. The invention can additionally be embodied entirely within any form of computer readable storage medium having stored therein an appropriate set of computer instructions for carrying out the techniques described herein. Thus, the various aspects of the invention may be embodied in many different forms, and all such forms are contemplated to be within the scope of the invention.

The aforementioned embodiments and description of the present invention are intended to be illustrative rather than restrictive. Many variations of implementing the present invention may be derived from the description contained herein by a person skilled in the art. All such variations and modifications are considered to be within the scope and spirit of the present invention, as defined by the following claims.

What is claimed is:

1. A method of financing purchases using a Property Linked-Credit Card associated with a specified property, the method comprising:
establishing an agreement between a card issuer and a card holder under which the card issuer will pay a merchant for a purchase made by the card holder using the Property Linked-Credit Card, and the card holder will pay the card issuer for the purchase, and under which the card holder establishes a possessory authority over the specified property;
issuing the Property Linked-Credit Card to the card holder upon establishment of said agreement; and
establishing an arrangement between the merchant and the card issuer under which the merchant charges the purchase made by the card holder against the card holder's Property Linked-Credit Card and obtains payment for the purchase from the card issuer, and limits the delivery of the purchase to the specified property.

2. The method of claim 1, wherein the card holder is a different legal entity than the card bearer.

3. The method of claim 1, wherein the card holder is the same legal entity as the card bearer.

4. The method of claim 1 wherein the card issuer takes a security interest in said specified property for financing said purchase.

5. The method of claim 1 wherein the card holder prescribes a pre-selected password to authorize a purchase using the Property Linked-Credit Card.

6. A method of financing purchases using a Property Linked-Credit Card associated with a vehicle, the method comprising:
establishing an agreement between a card issuer and a card holder under which the card issuer will pay a merchant for a purchase made by the card holder using the Property Linked-Credit Card, and card holder will pay the card issuer for the purchase, and under which the card holder establishes a possessory authority over the vehicle;
issuing the Property Linked-Credit Card to the card holder upon establishment of said agreement; and
establishing an arrangement between the card issuer and the merchant under which the merchant charges a purchase made by the card holder against the card holder's Property Linked-Credit Card and obtains payment for the purchase from the card issuer, and the purchase is conditioned upon the card holder presenting the vehicle for inspection and/or verification by the merchant.

7. The method of claim 6, wherein the card holder is a different legal entity than the card bearer.

8. The method of claim 6, wherein the card holder is the same legal entity as the card bearer.

9. The method of claim 6, wherein the card issuer takes a security interest in said specified property for financing said purchase.

10. The method of claim 6, wherein the card holder prescribes a pre-selected password to authorize a purchase using the Property Linked-Credit Card.

11. A method of financing purchases using a Property Linked-Credit Card associated with a specified property, the method comprising:
establishing an agreement between a card issuer and a card holder under which the card issuer will pay a merchant for a purchase made by the card holder using the Property Linked-Credit Card, and the card holder will pay the card issuer for the purchase, and under which the card holder establishes a possessory authority over the specified property and specifies a password or other identifier;
issuing the Property Linked-Credit Card to the card holder upon establishment of said agreement; and
establishing an arrangement between the merchant and the card issuer under which the merchant charges the purchase made by the card holder against the card holder's Property Linked-Credit Card and obtains payment for the purchase from the card issuer, and said merchant limits the use of the Property Linked-Credit Card to a legal entity that delivers to said merchant the specified password or other identifier.

12. The method of claim 11, wherein the card holder establishes the legal entity to be any one of a plurality of authorized users with authorization to make purchases using the Property Linked-Credit Card; and each of the authorized users establishes a unique password, and use of the Property Linked-Credit Card by said any one of a plurality of authorized users is conditioned upon tendering to said merchant the unique password or other identifier.

13. The method of claim 11, wherein the legal entity is restricted to conducting transactions in a predetermined geographic region.

14. The method of claim 11, wherein the legal entity is restricted to a predefined spending limit.

15. The method of claim 11, wherein the legal entity is restricted to a predefined spending limit for a given transaction type.

16. The method of claim 11, wherein the legal entity is restricted to using the Property Linked-Credit Card for only a predetermined transaction type.

17. A method of financing purchases by a card bearer using a Property Linked-Credit Card associated with a specified property, the method comprising:
establishing possessory authority by the card bearer over the specified property;
presenting said Property Linked-Credit Card to a merchant for a transaction to purchase goods or services;
allowing verification of the possessory authority by the card bearer over the associated property as a precondition for the transaction; and
receiving the goods or services of the transaction after the merchant has performed the verification.

18. The method of claim 17, wherein the step of receiving the goods or services further comprises:
receiving the goods or services in an automobile of the card bearer;
wherein the automobile is the specified property.

19. The method of claim 17, wherein the step of establishing possessory authority comprises driving an automobile which is the specified property.

20. The method of claim 17, wherein the specified property is an e-mail address and the step of establishing possessory authority comprises communicating with the merchant from the e-mail address.

21. The method of claim 17, further comprising:
providing a password associated with the card bearer to the merchant.

22. The method of claim 21, wherein the password is a first password and the card bearer is a first card bearer and the password is a first password, and wherein a second card bearer has a second password for the Property Linked-Credit Card.

23. The method of claim 17, wherein the card bearer is restricted to conducting transactions in a predetermined geographic region.

24. The method of claim 17, wherein the card bearer is restricted to a predefined spending limit.

25. The method of claim 17, wherein the card bearer is restricted to a predefined spending limit for a given transaction type.

26. The method of claim 17, wherein the card bearer is restricted to conducting a given transaction type.

27. The method of claim 26, wherein the given transaction type is an Internet transaction.

28. The method of claim 26, wherein the given transaction type is a telephone transaction.

29. A method of financing purchases by a card bearer using a Property Linked-Credit Card associated with a specified property, the method comprising:
establishing possessory authority over the specified property by the card bearer;
presenting said Property Linked-Credit Card to a merchant for a transaction to purchase goods or services; and
providing a password associated with the card bearer to the merchant, wherein the password is a first password and the card bearer is a first card bearer, and wherein a second card bearer has a second password for the Property Linked-Credit Card; and
arranging for delivery of the goods or services of the transaction to the specified property;
wherein the first password is associated with a first predetermined limitation on the first card bearer's use of the Property Linked-Credit Card, and the second password is associated with a second predetermined limitation on the second card bearer's use of the Property Linked-Credit Card.

30. A method of issuing a Property Linked-Credit Card associated with a specified property, the method comprising:
collecting application information from an applicant, wherein the application information comprises information about the specified property;
evaluating the application information; and
issuing the Property Linked-Credit Card associated with the specified property.

31. The method of claim 30, wherein the specified property is an e-mail address.

32. The method of claim 30, wherein the specified property is real estate.

33. The method of claim 30, wherein the specified property is an automobile.

34. The method of claim 30, wherein the step of issuing the Property Linked-Credit Card comprises:
providing one or more physical copies of the Property Linked-Credit Card to the applicant.
